(19) United States
(12) Patent Application Publication
(10) Pub. No.: US 2014/0270697 A1
(43) Pub. Date: Sep. 18, 2014

(54) SYSTEM FOR WIRELESS VIDEO AND AUDIO CAPTURING

(71) Applicant: Teradek LLC, Irvine, CA (US)

(72) Inventor: Nicolaas Louis Verheem, Laguna Niguel, CA (US)

(73) Assignee: Teradek LLC, Irvine, CA (US)

(21) Appl. No.: 14/198,462

(22) Filed: Mar. 5, 2014

Related U.S. Application Data
(60) Provisional application No. 61/804,571, filed on Mar. 22, 2013.
(60) Provisional application No. 61/794,210, filed on Mar. 15, 2013.

(51) Int. Cl. H04N 5/91; H04N 7/01

(52) U.S. Cl. CPC H04N 5/91; H04N 7/0125
USPC 386/232; 386/326

(57) ABSTRACT

Certain embodiments disclosed herein provide systems and/or methods in which digital video data from a wireless audio/video receiver system is written directly into memory of a computing device for storage or manipulation in order to save time delay, cost and/or size. Therefore, certain embodiments allow for storage and/or editing of video content without requiring conversion to a standard video interface by a device separate from the wireless receiver.

### RELATED APPLICATIONS

### Incorporation by Reference to any Priority Applications

This application claims the benefit under 35 U.S.C. §119(e) of U.S. Provisional Application No. 61/794,210, entitled “SYSTEM FOR WIRELESS VIDEO AND AUDIO CAPTURING,” filed Mar. 15, 2013, the entire content of which is incorporated by reference herein in its entirety and made part of this specification, and of U.S. Provisional Application No. 61/804,571, entitled “SYSTEM FOR WIRELESS VIDEO AND AUDIO CAPTURING,” filed Mar. 22, 2013, the entire content of which is incorporated by reference herein in its entirety and made part of this specification.

### BACKGROUND

Live video, such as news, can generate high revenue and/or interest on television and on the Internet. In order to obtain live media content transmissions, many organizations such as television (TV) stations, send camera crews to different locations where events of interest are occurring. The camera crews can take live video obtained at the location and then broadcast the live video.

### SUMMARY OF CERTAIN EMBODIMENTS

One embodiment discloses a system comprising, a transmitter device comprising, a controller configured to convert live video data received from a video acquisition device in a standard video interface to a first format configured for wireless transmission of the live video data; and an transmitter antenna configured to transmit a live video signal comprising the live video data wirelessly in the first format; and a receiver device comprising, a receiver antenna for receiving the video data signal comprising the live video data in the first format from the wireless transmitter; a controller in communication with a computing device and configured to write the live digital video data received from the transmitter directly into the memory of the computing device, wherein the live video data is not converted to the standard video interface prior to writing the live video data to the memory of the computing device.

Another embodiment discloses a method comprising, converting live video data received from a video acquisition device in a first format to a second format configured for wireless transmission of the live video data; and transmitting, by a first antenna, a live video signal comprising the live video data wirelessly in the second format; and receiving, by a second antenna, the video data signal comprising the live video data in the second format; writing the live video data received from the transmitter directly into the memory of the computing device, wherein the live video data is not converted to the first format prior to writing the live video data to the memory of the computing device.

A further embodiment discloses a receiver device comprising, an antenna configured to receive a video data signal comprising live video data in a first format from a wireless transmitter, wherein the live video data was received from a video acquisition device in a standard video interface and converted to the first format configured for wireless transmission; a front end configured to receive and process the video data signal in accordance with a wireless transmission protocol associated the wireless transmission from the wireless transmitter to retrieve the live video data from the video data signal; and a controller in communication with a computing device and configured to write the live video data received from the transmitter directly into memory of the computing device, wherein the live video data is not converted to the standard video interface prior to writing the live video data to the memory of the computing device.

Another embodiment discloses a computer-implemented method comprising, receiving, by a receiver device, a video data signal comprising live video data in a digital format from a wireless transmitter, wherein the live video data was received from a video acquisition device in a standard video interface and converted to the digital format configured for wireless transmission; processing the video data signal in accordance with a wireless transmission protocol associated the wireless transmission from the wireless transmitter to retrieve the live video data from the video data signal; and transferring the live video data received from the transmitter directly into memory of the computing device, wherein the live video data is not converted to the standard video interface prior to writing the live video data to the memory of the computing device.

Although certain embodiments and examples are disclosed herein, inventive subject matter extends beyond the examples in the specifically disclosed embodiments to other alternative embodiments and/or uses, and to modifications and equivalents thereof.

### BRIEF DESCRIPTION OF THE DRAWINGS

Various embodiments are depicted in the accompanying drawings for illustrative purposes, and should in no way be interpreted as limiting the scope of the disclosure. In addition, various features of different disclosed embodiments can be combined to form additional embodiments, which are part of this disclosure. Throughout the drawings, reference numbers may be reused to indicate correspondence between reference elements.

FIG. 1 is a network diagram schematically illustrating an embodiment of a live video transmission system.

FIGS. 2A-2B are network diagrams schematically illustrating embodiments of a live video transmission system for wireless video and audio capturing.

FIGS. 3A-3B illustrate flow diagrams for embodiments of a video data capture processes.

### DETAILED DESCRIPTION

Multi-camera live audio/video (A/V) switching systems are used in various levels of video production, such as live event webcasts (for example, talk shows), entertainment events (for example, live music performances), sports broadcasts, news shows, and the like. With adequate processing power, live video switching can be performed using software running on a desktop computer, or even a laptop computer equipped with the appropriate video capture card(s). Such solutions may provide relatively lower cost and smaller size in comparison to certain stand-alone A/V routing solutions. Furthermore, certain computers comprise sufficient processing power for handling multiple uncompressed video streams simultaneously. Advantageously, personal computer video switching technology may be realized using hardware that is substantially ubiquitous and applicable for other uses as well.

Separately, systems for sending audio/video signals wirelessly are also used in various video production applications. Wireless A/V transmission may serve to accommodate roving cameras, or transmissions from cameras positioned at distances and/or angles wherein the use of cables would be impractical or undesirable. Certain wireless A/V transmission solutions allow the required electronics to be embedded in devices having a relatively small form factor, which may provide reduced complexity and/or cost.

Certain wireless video systems are not designed to integrate with computer networks or computer memory, but operate primarily in the cable domain. For example, wireless video systems may generally output video in a format that can be run over a cable to a monitor or a recorder, though such format may not be compatible with internal computer storage and/or processing technology. Therefore, it may be necessary to utilize a video capture device, such as an external plug-in device or PCI expansion card, in order to record and/or edit certain A/V content on a computing device. There is a need for a system that allows live video and/or audio content to be transferred directly into the memory on a computing device where it can be manipulated or recorded without requiring the intermediate step of converting it to a standards-based transmission format prior to converting it back to “raw” video in memory.

Certain embodiments disclosed herein provide systems and/or methods in which digital video data from a wireless audio/video receiver system is written directly into memory of a computing device for storage or manipulation in order to save time delay, cost and/or size. Therefore, certain embodiments allow for storage and/or editing of video content without requiring conversion to a standard video interface by a device separate from the wireless receiver.

Certain embodiments disclosed herein provide a system including a wireless transmitter unit and a wireless receiver unit. The wireless transmitter unit is in communication with a camera, the transmitter unit can be mounted on the camera, in proximity of the camera, or built into the camera. The wireless transmitter unit can be configured to receive data from the camera, including video data, audio data, and metadata in a standard video interface, convert the standard video interface to a “raw” digital format that can be transmitted to a receiver unit as a digital data signal. The wireless receiver unit is in communication with a computing device and is configured to receive the “raw” digital data signal from the wireless transmitter unit, and write the video data, audio data, and metadata included in the digital data signal directly to the memory of the computing device without converting the “raw” digital data format to a standard video interface.

The “raw” format refers to a digital format suitable for wireless transmission protocols, such as transmission protocols according to Wi-Fi (802.11 a/b/g/n/ac and so forth), orthogonal frequency division multiplexing (OFDM), coded orthogonal frequency division multiplexing (COFDM), WHDI (Wireless Home Digital Interface) or other wireless transmission protocols. The raw format can also be suitable for storage in the memory of a computing device without conversion from the raw format to a different format.

By eliminating the process of converting the baseband “raw” digital audio/video/metadata signal back to a standard video signal like a serial digital interface (SDI) or high definition multimedia interface (HDMI), Digital Video Interface (DVI) or any analog video standards like NTSC or Component video), and then reconverting the data in order to transfer the data into memory of a computing device, the system may save cost, size and delay (latency) on the video signal path, which can provide a substantial benefit in live productions. The benefit may be even more substantial when a live broadcast uses multiple cameras, where some or all of the cameras must be synchronized.

FIG. 1 is a network diagram schematically illustrating one embodiment of an example of a live video transmission system 100 for capturing live video content. In some embodiments, components of the system may include products from Teradek, LLC of Irvine, Calif. The system 100 includes a wireless transmitter 140 configured to transmit video and/or audio content received from a video camera 130 or other live video source over a wireless network, such as the Internet. The camera 130 may be operated by a stringer or other video acquisition personnel. The camera 130 may be a stand-alone device or it may be part of computing system, including the computing systems discussed below. The wireless transmitter 140 may include data encoding functionality for converting video data received from the camera 130 into a format suitable for wireless transmission, such as transmission according to Wi-Fi, OFDM, COFDM, WHDI or other wireless transmission protocols.

The wireless transmitter 140 may be disposed in physical proximity to the camera. For example, the wireless transmitter 140 may be on-location with the camera 130 while the camera 130 records live video for transmission and processing by the system 100. In certain embodiments, the wireless transmitter is physically connected or mounted to the camera, or may be integrated with internal camera electronics.

In certain embodiments, such as where bandwidth is limited at a video acquisition/transmission location (for example, a breaking news site), the wireless transmitter 140 may be configured to split the video stream into separate streams for transmission on multiple network paths (for example, cellular networks, landlines, Wi-Fi, combinations of the same, or the like). In such an embodiment, the wireless receiver 150 may be configured to receive the split streams and combine them into a single video stream.

The wireless transmitter 140 receives video data from one or more cameras 130 and encodes and transmits the data to the wireless receiver 150. The data transmitted by the wireless transmitter may contain one or more of the following types of data: audio, video, metadata (for example, timestamp data, lens data, and the like). Although transmitted data may contain one or more of the above-recited types of data, certain embodiments are disclosed herein in the context of video data for convenience. However, it should be understood that references to video data herein may refer to any type of data that may be transmitted wirelessly over a networked connection. In one embodiment, the wireless transmitter 140 includes one or more transmitters, such as cellular modems (for example, 3G or 4G modems), Wi-Fi devices (802.11 a/b/g/n/ac and so forth) or other wireless transmitters.

In one embodiment, the wireless transmitter 140 provides high definition (HD) streaming. For example, the transmitter 140 may be configured to stream up to 1080p30 video directly to the wireless receiver 150. The transmitter 140 may be configured to support one or more various transmission protocols, such as RTMP, Real-time Transport Protocol (RTP)/RTSP, RTP Push, MPEG-TS, and/or Hypertext Transfer Protocol (HTTP) Live Streaming (HLS), or the like. The transmission by the wireless transmitter can be digital and/or analog. In one embodiment, the transmitter 140 device supports streaming over various transmission systems or transmitters, such as dual band multiple-input and multiple-output (MIMO) Wi-Fi, standard Wi-Fi, Ethernet, or one or more 3G/4G USB modems. The wireless transmitter can include one or more of the following features: a built-in battery (for example, lithium-ion or nickel-cadmium), a display (for example, organic light-emitting diode (OLED), liquid crystal display (LCD), and so forth), a removable memory port (for example, microSD), a sound output (for example, headphone output), and/or a wireless interface (for example, MIMO Wi-Fi technology, 802.11 or other wireless interface).

In one embodiment, the wireless transmitter 140 comprises a transmission manager module configured to aggregate the bandwidth of one or more 3G/4G universal serial bus (“USB”) modems (for example, 1-5 or more than 5 modems), including modems from various cellular carriers. In one embodiment, the transmission manager dynamically adjusts the video bit rate and buffer of a video stream in real time to adapt to varying network conditions, allowing content to be delivered reliably and at a quality commensurate with the available bandwidth. For example, if cellular service at a location drops to levels that are too slow to transmit an HD quality video, the transmission manager can begin to drop the frame rate until the content reaches its destination intact. This feature can be beneficial in situations such as breaking news coverage where successful video transmission is very important.

The wireless receiver 150 includes an antenna and front end receiver module for receiving and processing the wireless video data. The front end module may comprise one or more discrete components for receiving and processing the wireless video data transmitted by the wireless transmitter 140. For example, the front end module may comprise circuitry for processing the received data at the incoming frequency, as well as for down converting the signal to an intermediate, or baseband, frequency for processing. The front end circuitry may include one or more of the following analog components: low-noise amplifier, bandpass filter, local oscillator, mixer, automatic gain control and/or other components. The front end module may further include an analog-to-digital converter for digital signal processing.

In some embodiments, a wireless receiver 150 includes a video driver device configured to encode the live video stream into a standard video interface, such as HDMI, SDI or the like. For example, the wireless video stream may be transmitted in H.264 format or another coding format and encoded by the wireless receiver 150 into a standard video interface. In some embodiments, the wireless video stream may also be encrypted to prevent unauthorized access to the video stream. The wireless receiver 150 may be equipped with an appropriate decryption keys for decrypting the video stream when it is received.

In some embodiments, the wireless receiver 150 provides the video signal to a video capture device 160 in a standard video interface. The video capture device may be an expansion card communicatively coupled to a computer bus or interface of the computing device 170. For example, the video capture device may be installed into an expansion slot the computing device's motherboard; and the communication between the card and the computer memory 175 may be via PCI, PCI-Express, and PCI-Express 2.0, or other communication protocol. The computing device 170 may be implemented as one more computing systems discussed further below.

Alternatively, the video capture device 160 may be a device external to the computing device 170 that is configured to interface with the computer memory 175, such as via a USB interface, or the like. For example, the video capture device 160 may comprise electronics within an external housing having one or more input ports for receiving video data, as well as one or more output ports for providing a communicative connection with the computing device 170.

The video capture device 160 may be configured to receive and render digital video data and/or analog video data. For capturing of digital video data, the video capture device may receive the video stream from the wireless receiver 150 via one or more HDMI, and/or or other high-definition video input ports. In certain embodiments, the video capture device 160 is configured to accept uncompressed video data. Alternatively, or additionally, the video capture device 160 may be configured to accept data compressed according to one or more coding standards, such as play H.264, MPEG-4, MPEG-2, VOB and ISO images video, MP3 and AC3 audio data, or other data formats.

The video capture device 160 is configured to convert the video data into a format that is useable by the computing device 170. In certain embodiments, the video capture device 160 includes one or more onboard processors that handle the conversion of the video data. Video data that has been formatted by the video capture device may be buffered in local storage.

The video capture device 160 includes a memory access controller. The memory access controller can be configured to communicatively interface with a direct memory access (DMA) controller of the computing device. The memory access controller can be configured to allow the video capture device to access the computer memory 175 independently of the central processing unit (CPU) of the computing device 170. By interfacing with the DMA controller video data can be stored in the computer memory 175 with minimal CPU overhead. The DMA controller may be configured to generate addresses and initiate memory read or write cycles, and may contain one or more memory registers that can be written and read by the CPU.

The computing device can be configured to display, store and alter the video data. The video data can altered, edited, an/or manipulated in various ways, including mixing with video data from other live video feeds or playback video feeds, overlaying text or graphics on the video data, adding subtitles, replacing green screens with virtual backgrounds, and other types of alterations. In some embodiments, the computing device 170 may operate distributedly on several networked computing devices. The computing device 170 can include one or more computing devices that may be operating on a network with access to the global internet. The global internet can be a publicly accessible network of networks, such as the Internet.

FIG. 2 is a network diagram schematically illustrating an embodiment of a live video transmission system 200 for wireless video and audio capturing. The system 200 includes many similar components to the system 100 described above with respect to FIG. 1. Therefore, for the sake of succinctness, discussion of FIG. 2 herein focuses primarily on possible distinctions between the systems. It should be understood that the various components of the system 200 may include similar features and/or functionality as the system 100 of FIG. 1.

In the system 200, video data may be provided by a wireless receiver to internal memory of a computing device without transmitting the video data first to an intermediate video capture device separate from the wireless transmitter. As shown, the system 200 includes a wireless receiver 250 configured to receive wireless data transmissions from a wireless transmitter 240. In certain embodiments, the receiver 250 may have the form factor of an expansion card configured to be plugged into a computing device. In another embodiment, the receiver 250 may be a self-contained device. The wireless receiver 250 may be powered by an internal battery, an external power source, such as over a serial communications bus, such as USB, Firewire, ThunderBolt, or the like, or through electrical communication with an external power grid or other external power source. In certain embodiments, the wireless receiver 250 is a “virtual capture card.” The virtual capture card can be a software driver installed on the computing device 270 capable of implementing the functionality associated with the wireless receiver 250, wherein the software driver may act as if it is a real piece of hardware.

The wireless receiver 250 may include one or more built-in antennas to receive the wireless signal. In another embodiment, the receiver 250 includes one or more external antenna connectors to allow for connection of the utilization of possibly higher-gain antennas, or remotely placed antennas. In some embodiments, the wireless receiver 250 uses link aggregation protocols, such as those employed by Teradek's Bond product, to reconstruct live video feeds from multiple transmitting sources and make it available for recording or rebroadcasting in a number of standard formats, as illustrated in FIG. 2B.

In one embodiment, the data sent from the transmitter 240 to the receiver 250 may be compressed data (for example, H.264, advanced video coding (AVC), H.265, high efficiency video coding (HEVC), or the like). Alternatively, the data sent from the transmitter 240 to the receiver 250 may be uncompressed data (for example, OFDM, quadrature amplitude modulation (QAM), chroma subsampling, such as 4:2:2, 4:2:0, or the like). In certain embodiments, the data transmission between the wireless transmitter 240 and the wireless receiver 250 is based on Internet Protocol. Furthermore, the data sent from the transmitter 240 to the receiver 250 may include proprietary data.

The data sent from the transmitter 240 the receiver 250 may be transmitted point-to-point (one-to-one), or may be a multicast transmission (one-to-many). Furthermore, the data sent from the transmitter 240 the receiver 250 may be frame-based audio/video/metadata data, pixel-based, or may comprise an isochronous (continuing) stream of data. In one embodiment, the data may be converted back into a standard video interface like HDMI or SDI to monitor or record on an external device. The data transmitted from the wireless transmitter 240 to the wireless receiver 250 may be sent over a local area network (wireless LAN), or may be sent over a wide-area network (WAN), or over the public Internet. For example, wherein the data is transmitted over the Internet, the receiver 250 may be a virtual capture card, presenting the IP data from the Internet to the computer 270 as if it is a physical (local) connection.

As shown in the system 200 of FIG. 2, the wireless receiver 250 comprises a memory access controller for communication between the wireless receiver 250 and the computing device memory 275. The separate video capture device 160 shown in FIG. 1 is bypassed, thereby potentially providing reduced system complexity, cost, and/or time of operation. By bypassing the video capture device 160, it may not be necessary to convert the video data into standard video interface and back into raw video data in the receiver chain.

FIG. 2B illustrates another embodiment of a live video transmission system 200′ for wireless video and audio capturing. In this embodiment, the wireless receiver 250′ has a plurality of antennas configured to receive video data streams from the wireless transmitters 240. The wireless receiver 250′ can be configured to aggregate the video data received from the one or more wireless transmitters. In the illustrated embodiment, the system can have a plurality of wireless transmitters that are configured to transmit video data signals to the wireless receiver. The wireless transmitters can be configured to transmit a plurality of data signals from a plurality of cameras, which may be synchronized. The wireless transmitters can also be configured to split a single live video stream from a single camera into multiple streams for transmission over the plurality of transmitters 240.

The plurality of antennas of the one or more wireless receivers 250′ can be configured to receive the video data signals from the different wireless transmitters. The different video data signals can be received and processed by the front end associated with each antenna. In certain embodiments, the video data can be transferred to a plurality of computing devices 270 for processing, storage and editing. For example, if multiple synchronized video data signals are received by the wireless receivers, each video data signal can be processed by a separate computing device, which can help reduce delay (latency) of the video signal path for the synchronized video streams.

FIGS. 3A and 3B are flow diagrams illustrating transmitter and receiver paths, respectively, for an embodiment of a video data capture process. The process 300A shown in FIG. 3A includes acquiring live video at block 310 using a camera or other video acquisition device. For example, live video may be acquired using an onsite video camera. Video data acquired by the video camera may be transferred to a wireless transmitter device in a standard video interface, such as HDMI, SDI or the like. The video data may be acquired by multiple video acquisition devices.

At block 320, the live video data is transmitted to the wireless transmitter device, which may be performed over a wired or wireless communication link. In certain embodiments, the wireless transmitter is disposed in physical proximity to the camera. For example, the wireless transmitter may be secured or mounted to the camera. In the case of multiple video acquisition devices, the live video data from each device may be transferred to one or more wireless transmitters.

At block 330, the wireless transmitter converts the video data into a format suitable for wireless transmission. For example, the wireless transmitter may convert the video data to comply with a desirable wireless protocol, such as Wi-Fi, OFDM, COFDM, or the like.

At block 340, the live video data is wirelessly transmitted to a wireless receiver. The wireless transmitter may be configured to split the video stream into separate streams for transmission on multiple network paths (for example, cellular networks, landlines, Wi-Fi, combinations of the same or the like).

FIG. 3B shows a flow chart illustrating an embodiment of the receiver path for the video data capture process 300B. At block 350, the wireless receiver receives the wireless video data via a wireless video data signal transmitted by the wireless transmitter. The video data signal can be received and processed by a front end device. In embodiments where the wireless transmitter splits the wireless data signal into multiple streams, which may be received over multiple network paths, the wireless receiver can be configured to receive the split streams and combine them into a single video stream to extract coherent video data. In certain embodiments, the wireless receiver may have a plurality of wireless receivers configured to receive video data signals. In such embodiments, the wireless receiver can be configured to aggregate and process each of the video data signals such that the video data signals can be combined into a single video stream.

At block 360, the wireless receiver can transfer the video data to memory of a computing device over a computer bus or interface. The video data received from the transmitter is in a format that allows it to be transferred directly to the memory of the computing device without an interim conversion of the video data to a standard video interface. The wireless receiver can have a memory access controller configured to provide access the computing device's memory and communicate with a processor of the computing device to coordinate the transfer of the video data directly the memory of the computing device.

At block 370, the computing device can store and/or edit the video data provided by the wireless receiver using the computer's resources.

It is recognized that other embodiments of FIGS. 3A and 3B may be used. For example, the transmission could be in done in part via a wired transmission and/or the wireless transmitter may be integrated as part of the camera.

### Computing System

The camera 130 and/or the computing device 170 may include or run on a computing system, which includes for example, a personal computer that is IBM, Macintosh, or Linux/Unix compatible or a server or workstation. In various embodiments, the computing system comprises a server, a laptop computer, at tablet, a smart phone, a personal digital assistant, a video camera, a digital camera, or a media player, for example. In one embodiment, the computing system includes one or more CPUs, which may each include a conventional or proprietary microprocessor. The computing system further includes one or more memory, such as random access memory (“RAM”) for temporary storage of information, one or more read only memory (“ROM”) for permanent storage of information, and one or more mass storage device, such as a hard drive, diskette, solid state drive, or optical media storage device. Typically, the modules of the computing system are connected using a standard based bus system. In different embodiments, the standard based bus system could be implemented in Peripheral Component Interconnect (PCI), Microchannel, Small Computer System Interface (SCSI), Industrial Standard Architecture (ISA) and Extended ISA (EISA) architectures, for example. In addition, the functionality provided for in the components and modules of computing system may be combined into fewer components and modules or further separated into additional components and modules.

The computing system is generally controlled and coordinated by operating system software, such as Windows XP, Windows Vista, Windows 7, Windows 8, Windows 2010, Windows 2013, Windows Server, Unix, Linux, SunOS, Solaris, iOS, Blackberry OS, Android, or other compatible operating systems. In Macintosh systems, the operating system may be any available operating system, such as MAC OS X. In other embodiments, the computing system may be controlled by a proprietary operating system. Conventional operating systems control and schedule computer processes for execution, perform memory management, provide file system, networking, I/O services, and provide a user interface, such as a graphical user interface (GUI), among other things.

The computing system may include one or more commonly available I/O interfaces and devices, such as a keyboard, mouse, touchpad, and printer. In one embodiment, the I/O interfaces and devices include one or more display devices, such as a monitor, that allows the visual presentation of data to a user. More particularly, a display device provides for the presentation of GUIs, application software data, and multimedia presentations, for example. The computing system may also include one or more multimedia devices, such as speakers, video cards, graphics accelerators, and microphones, for example.

The computing system may include I/O interfaces and devices, which provide a communication interface to various external devices. In addition, they computing system may be electronically coupled to a network, which comprises one or more of a LAN, WAN, and/or the Internet, for example, via a wired, wireless, or combination of wired and wireless communication link. The network communicates with various computing devices and/or other electronic devices via wired or wireless communication links.

In some embodiments, information may be provided to the computing system over the network from one or more data sources. The data sources may include one or more internal and/or external databases, data sources, and physical data stores. The data sources may include internal and external data sources. In some embodiments, one or more of the databases or data sources may be implemented using a relational database, such as Sybase, Oracle, CodeBase, and Microsoft® SQL Server, as well as other types of databases such as, for example, a flat file database, an entity-relationship database, and object-oriented database, and/or a record-based database.

The computing system may include modules which themselves may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, Lua, C and/or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the computing system, for execution by the computing device. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

### ADDITIONAL EMBODIMENTS

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by the system and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the systems and methods. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

What is claimed is:

1. A system comprising:
a transmitter device comprising
a controller configured to convert live video data received from a video acquisition device in a standard video interface to a first format configured for wireless transmission of the live video data; and
a transmitter antenna for transmitting a live video signal comprising the live video data wirelessly in the first format; and
a receiver device comprising:
a receiver antenna for receiving the video data signal comprising the live video data in the first format from the wireless transmitter; and
a controller in communication with a computing device and configured to write the live video data received from the transmitter directly into the memory of the computing device, wherein the live video data is not converted to the standard video interface prior to writing the live video data to the memory of the computing device.

2. The system of claim 1, wherein the live video data comprises video data, audio data and metadata.

3. The system of claim 1, wherein the standard video interface is high definition multimedia interface.

4. The system of claim 1, wherein the first format is configured for wireless transmission using at least one of orthogonal frequency division multiplexing and coded orthogonal frequency division multiplexing.

5. The system of claim 1, wherein the controller is in communication with a direct memory access controller of the computing device.

6. The system of claim 1, wherein the first format is a digital format.

7. The system of claim 1 further comprising a front end configured to receive and process the video data signal in accordance with a wireless transmission protocol.

8. The system of claim 1, wherein the transmitter device is further configured to split the live video data into a plurality of video data signals for transmission to the receiver device.

9. The system of claim 8, wherein the receiver device is further configured to combine the plurality of video data signals into a single aggregate data signal.

10. The system of claim 1, wherein the video acquisition device is a camera.

11. The system of claim 1, wherein the computing device is configured to store and/or edit the live video data.

12. A method comprising:
converting live video data received from a video acquisition device in a first format to a second format configured for wireless transmission of the live video data; and
transmitting, by a first antenna, a live video signal comprising the live video data wirelessly in the second format;
receiving, by a second antenna, the video data signal comprising the live video data in the second format; and
writing the live video data received from the transmitter directly into the memory of the computing device, wherein the live video data is not converted to the first format prior to writing the live video data to the memory of the computing device.

13. The method of claim 12, wherein the live video data is associated with a live video broadcast.

14. The method of claim 12 further comprising:
splitting the live video data into a plurality of video data signals; and
transmitting, by the first antenna, the plurality of video data signals.

15. A receiver device comprising:
an antenna configured to receive a video data signal comprising live video data in a first format from a wireless transmitter, wherein the live video data was received from a video acquisition device in a standard video interface and converted to the first format configured for wireless transmission;
a front end configured to receive and process the video data signal in accordance with a wireless transmission protocol associated the wireless transmission from the wireless transmitter to retrieve the live video data from the video data signal; and
a controller in communication with a computing device and configured to write the live video data received from the transmitter directly into memory of the computing device, wherein the live video data is not converted to the standard video interface prior to writing the live video data to the memory of the computing device.

16. The system of claim 15, wherein the live video data comprises video data, audio data and metadata.

17. The system of claim 15, wherein the standard video interface is high definition multimedia interface.

18. The system of claim 15, wherein the wireless transmission protocol uses at least one of orthogonal frequency division multiplexing and coded orthogonal frequency division multiplexing.

19. The system of claim 15, wherein the controller is in communication with a direct memory access controller of the computing device.

20. The system of claim 15 further comprising a plurality of antennas for receiving a plurality of video data signals from the transmitter.

21. The system of claim 20 wherein the receiver is further configured to aggregate the plurality of video data signals into a single aggregate video data signal.

22. A computer-implemented method comprising:
receiving, by a receiver device, a video data signal comprising live video data in a first format from a wireless transmitter, wherein the live video data was received from a video acquisition device in a standard video interface and converted to the first format configured for wireless transmission;
processing the video data signal in accordance with a wireless transmission protocol associated the wireless transmission from the wireless transmitter to retrieve the live video data from the video data signal; and
transferring the live video data received from the transmitter directly into memory of the computing device, wherein the live video data is not converted to the standard video interface prior to writing the live video data to the memory of the computing device.

23. The method of claim 22, wherein the video data signal comprises a plurality of data streams that are received by the receiver device from multiple network paths.
